(19) United States
(12) Patent Application Publication
(10) Pub. No.: US 2023/0125115 A1
(43) Pub. Date: Apr. 27, 2023

(54) METHODS AND APPARATUS FOR EFFICIENT CORRECTION OF A PARAMETER ASSOCIATED WITH A NAVIGATION SATELLITE OR THE PROPAGATION OF SIGNALS TRANSMITTED THEREBY

(71) Applicant: HERE GLOBAL B.V., Eindhoven (NL)

(72) Inventors: Saara Kuismanen, Tampere (FI); Pekka-Henrik Niemenlehto, Nokia (FI)

(73) Assignee: HERE GLOBAL B.V., Eindhoven (NL)

(21) Appl. No.: 17/510,514

(22) Filed: Oct. 26, 2021

(51) Int. Cl. G01S 19/07

(52) U.S. Cl. CPC G01S 19/072

(57) ABSTRACT

A method, apparatus and computer program product determine a position of a client computing device. In the context of a method, a parameter, such as an orbit or a clock, associated with a respective navigation satellite are predicted, with the client computing device, based on data associated with the respective navigation satellite. The method also includes providing time information to a correction service identifying the data used as a basis for predicting the parameter associated with the respective navigation satellite. The method further includes receiving, from the correction service, a correction to the parameter that has been predicted for the respective navigation satellite and determining the position of the client computing device based upon the parameter that has been predicted for the respective navigation satellite in combination with the correction thereto.

### TECHNOLOGICAL FIELD

An example embodiment relates generally to correcting a parameter, such as at least one of an orbit or a clock, associated with a navigation satellite or signals transmitted by the navigation satellite in a manner that is reliant upon interaction between a client computing device and a server computing device to enable the position of the client computing device to be determined both accurately and efficiently.

### BACKGROUND

Positioning and navigation solutions commonly depend upon a Global Navigation Satellite System (GNSS) with signals transmitted by a GNSS satellite being received by GNSS receivers embedded in or otherwise carried by a variety of different devices. For example, smartphones, smart watches, vehicles, drones and other location-aware devices include GNSS receivers in order to allow the position of the device to be determined. In some instances, the device may include a navigation system and/or a navigation application that is dependent upon the signals received by the GNSS receiver in order to determine the position of the device and to provide navigational assistance. The number of devices that include GNSS receivers is growing rapidly with more types of devices including devices, such as Internet of Things (IOT) devices, with limited amounts of computational resources including GNSS receivers.

The GNSS family includes several satellite constellations including the Global Positioning System (GPS) and the Globalnaya Navigatsionnaya Sputnikovaya Sistema (GLONASS) system. Other GNSS satellite constellations include the Beidou system and the Galileo system. In addition to these global satellite constellations, several regional Satellite-Based Augmentation Systems (SBAS), such as the Quazi-Zenith Satellite System (QZSS), Multifunctional Transport Satellites (MTSAT) Satellite Augmentation System (MSAS), Wide Area Augmentation System (WAAS), European Geostationary Navigation Overlay Service (EGNOS), GPS-Aided Geostationary (GEO) Augmented Navigation (GAGAN), System for Differential Correction and Monitoring (SDCM) and the Indian Regional Navigation Satellite System (IRNSS) having an operational name of NavIC (Navigation with Indian Constellation), have been developed.

In a GNSS system, a navigation satellite orbiting the Earth transmits navigation signals including ranging codes and navigation data interleaved with the ranging codes that a GNSS receiver receives and utilizes to determine the position of the GNSS receiver and, in turn, the device in which the GNSS receiver is embedded. The ranging code allows the GNSS receiver to determine the time required for the signals to travel from the navigation satellite to the GNSS receiver, which correlates to the distance between the navigation satellite and the GNSS receiver. The navigation data includes a set of parameter values of an orbit model defining the orbit of the navigation satellite for a limited period of time. The parameter values are known as ephemeris data. The ephemeris data may be utilized by the GNSS receiver to determine the position the navigation satellite relative to a predefined coordinate system at particular instances of time. Based on the positions of a plurality of navigation satellites, the clock information of the navigation satellites, such as the clock offsets of the navigation satellites relative to GNSS time, and the time required for the signals broadcast by the navigation satellites to be received by the GNSS receiver, the GNSS receiver is configured to determine its position.

A GNSS receiver that relies solely upon signals received from navigation satellites may not be capable of determining its position with sufficient accuracy and/or in a sufficiently rapid manner in certain situations. In this regard, GNSS was originally designed for outdoor applications in which a GNSS receiver could continuously receive signals from the navigation satellites. However, in instances in which the signal conditions between a navigation satellite and a GNSS receiver are weak, such as in urban areas and, more particularly, within urban canyons, the position of the GNSS receiver may not be able to be accurately determined. Additionally, the time-to-first-fix (TTFF), that is, the time required for a GNSS receiver to initially determine its position based upon signals received from a navigation satellite may be longer than desired for certain applications, such as a navigation application that demands the relatively timely determination of position.

In order to improve upon the performance of a GNSS receiver in relation to the accuracy and timeliness with which the position of the GNSS receiver is determined, assisted-GNSS technology was developed. In this regard, assisted-GNSS recognizes that the ranging codes transmitted by a navigation satellite would generally be received by a GNSS receiver, even in relatively weak signal conditions, but that the navigation data interleaved with the ranging codes may become too noisy and erroneous for successful demodulation in certain circumstances, such as in an urban environment. As such, assisted-GNSS technology utilizes a global monitoring network for capturing the navigation data transmitted by navigation satellites and for providing at least some of the navigation data to a GNSS receiver as assistance data, such as via the Internet or other terrestrial communication systems or networks. In one example, an assisted GNSS Positioning service may provide GNSS assistance data, such as via, e.g., the HERE GNSS API from HERE Technologies that provides correction and assistance data including predicted assistance data.

Assistance data generally includes a set of information elements carrying information identifying a reference location and a reference time as well as navigation data from a navigation satellite. Access to the assistance data and potentially to additional information, such as the reference frequency of a modem utilized by the GNSS receiver, by the GNSS receiver may improve the performance of the GNSS receiver. For example, the availability of assistance data may permit the time-to-first-fix to be reduced, such as to about 5 to 10 seconds, for a position determination having an accuracy of about 5 meters in contrast to a time-to-first-fix that may be in a range of about 30 to 40 seconds for a GNSS receiver without assistance data. Recognizing the importance of assistance data to GNSS performance, the lifetime of assistance data has been extended and the assistance data has become more readily available to GNSS receivers, both in the form of online assistance data as well as offline assistance data. In this regard, offline assistance data can be utilized even in instances in which there would otherwise have been a delay in establishing a network connection to obtain online assistance data or an inability to establish a network connection to obtain online assistance data, such as in an instance in which the requisite roaming data plan is not available.

The ephemeris data that defines the orbit model has a certain, limited lifetime, such as 2 to 4 hours, during which the parameter values are valid and the position of the satellite can be estimated based thereupon with a desired accuracy. Following the transmission of the ephemeris data, the accuracy with which the position of the navigation satellite is defined by the parameter values decreases as the age of the ephemeris data for the satellite increases. Eventually, the GNSS receiver must receive a new set of ephemeris data for the navigation satellite if the position of the GNSS receiver is to be determined with sufficient accuracy. However, the acquisition of ephemeris data from the navigation satellite may be a time-consuming process taking up to several minutes or may require substantial network access.

As a result, an Ephemeris Extension Service (EES) is available to extend the useful lifespan of the ephemeris data with the extension based on a model of the orbit of the navigation satellite and, in some instances, the clock on-board of the navigation satellite. In a typical EES system, the orbit of a satellite is predicted by integrating output values of an equation of motion defined for the satellite. The last reliable position of the satellite that can be determined with the ephemeris data may be utilized as an initial state of the orbit for the integration. The predictions of the orbit of a satellite provided by an EES can be formatted in various manners including as a continuous polynomial function, such as a spline or Hermitea polynomial function, as a piecewise continuous function or as a delta or differential correction to the broadcast ephemeris data or almanac, etc. The equation of motion may be referenced as a force model, as the equation is based on forces acting upon the satellite. Although the orbit of the satellite may be predicted most accurately by including all forces that have a distinguishable effect upon the satellite, the equation of motion generally includes only the forces that contribute most significantly to the position of the satellite, such as by including the gravitational forces of the earth, the sun and the moon, as well as solar radiation pressure.

Several Ephemeris Extension Services are available including the ephemeris extension technology included in the 3rd Generation Partnership Project (3GPP) standards beginning with Release8 and available for GPS, GLONASS and Galileo systems. This ephemeris extension technology provides differential corrections to a reference ephemeris. In addition, other types of Ephemeris Extension Services that are available include those provided by the HERE GNSS API from HERE Technologies as well as GPSOneXtra from Qualcomm Technologies, Inc., Long-Term Orbit (LTO) from Broadcom Inc. and Predicted GPS (PGPS) from RX Networks, Inc. These other types of Ephemeris Extension Services also allow the ephemeris lifetime to be extended, such as for several days or even weeks.

The accuracy of the predictions of the position of a navigation satellite beyond the lifetime of the ephemeris data that are provided by ephemeris extension is increasingly diminished as more time passes since the expiration of the lifetime of the most recent ephemeris data. To improve the performance of GNSS positioning, the position of the navigation satellite at different points in time that is predicted based upon ephemeris extension can be corrected. However, the determination of the correction of the predicted position of the navigation satellite may require more computational capacity than a device that incorporates the GNSS receiver may desire to dedicate to position determination. These limitations on the computational capacities of a device that are available to determine corrections to the predicted position of a navigation satellite may become more prevalent as GNSS receivers are incorporated in more consumer grade devices that may have a limited computational capacity, such as IoT devices.

The correction data upon which the corrections to the predicted position of the navigation satellite is based may be provided by a correction service, such as via a network connection. As noted above, some devices in which a GNSS receiver is embedded may not have network access or may have only limited network access, thereby correspondingly limiting the availability of the correction data. Additionally, the devices in which a GNSS receiver is embedded may have limitations upon the quantity of data that may be received as well as a frequency with which data may be received, which also serves to limit the availability of timely correction data and correspondingly limits the accuracy with which the position of the navigation satellite and, in turn, the position of the device in which the GNSS receiver is embedded, may be determined.

Other techniques for improving the performance of GNSS-base positioning include differential GNSS (d-GNSS), real-time-kinematic technology (RTK) and precise point positing (PPP), as well as techniques that combine other positioning sources to improve performance such as inertial sensor integration, and the analysis of Wi-Fi or Bluetooth signals. However, these techniques may also require more frequent data flow and/or the availability of additional sensors or antennas. As such, at least some devices that incorporate GNSS receivers may not be capable of utilizing these other techniques for improving the performance of GNSS positioning.

### BRIEF SUMMARY

A method, apparatus and computer program product are provided for determining the position of a client computing device in an efficient and accurate manner utilizing a correction to a parameter that had been predicted for a respective navigation satellite or the propagation of signals transmitted by the respective navigation satellite. In order to accurately determine the position of the client computing device without consuming substantial computing resources of the client computing device, the parameter, such as the orbit and/or the clock, associated with a navigation satellite may be predicted by the client computing device based on data, e.g., ephemeris data, while a correction to the parameter may be determined by a server computing device, such as a correction service provided by the server computing device. As the server computing device receives the correction data from which the correction to the parameter is determined, the client computing device of this example embodiment may still be able to correct the parameter associated with the navigation satellite based on a correction provided by the server computing device in an instance in which the client computing device is unable to consistently maintain a network connection, thereby providing for more accurate positioning than reliance by the client computing device solely upon a prediction of the parameter.

In an example embodiment, a method is provided for determining a position of a client computing device. The method includes predicting, with the client computing device, a parameter associated with a respective navigation satellite or propagation of signals transmitted by the respective navigation satellite based on data associated with the respective navigation satellite or the propagation of signals transmitted thereby. The method also includes providing, to a correction service, time information identifying the data used as a basis for predicting the parameter associated with the respective navigation satellite or the propagation of signals transmitted by the respective navigation satellite. The method further includes receiving, from the correction service, a correction to the parameter that has been predicted and determining the position of the client computing device based at least in part upon the parameter that has been predicted in combination with the correction thereto.

The method of an example embodiment also includes applying the correction to the parameter that has been predicted for the respective navigation satellite or the propagation of signals transmitted by the respective navigation satellite in order to update the parameter that has been predicted. The method of an example embodiment predicts the parameter by predicting one or more of an orbit or a clock of the respective navigation satellite based on ephemeris data associated with the respective navigation satellite, and receives the correction by receiving a correction to one or more of the orbit or the clock that have been predicted. In this example embodiment, the method may predict one or more of the orbit or the clock of the respective navigation satellite by utilizing ephemeris extension initialized with the ephemeris data to predict one or more of the orbit or the clock of the respective navigation satellite. The method of an example embodiment predicts the parameter by predicting one or more of a code bias, an ionospheric model, a tropospheric model or a phase bias and receives the correction by receiving a correction to the one or more of the code bias, the ionospheric model, the tropospheric model or the phase bias that have been predicted. In this example embodiment, the method determines the position of the client computing device by determining the position of the client computing device based also upon the one or more of the code bias, the ionospheric model, the tropospheric model or the phase bias that have been predicted in combination with the correction thereto. In an example embodiment, the correction to the one or more of the code bias, the ionospheric model, the tropospheric model or the phase bias may be received from the correction service at an update rate that is less than the update rate at which the correction to one or more of the orbit or the clock is received from the correction service. The method of an example embodiment receives the correction to one or more of the orbit or the clock by receiving the correction to one or more of the orbit or the clock as a polynomial model.

In another example embodiment, an apparatus embodied by a client computing device is provided that is configured to determine a position of the client computing device. The apparatus includes processing circuitry and at least one non-transitory memory including computer program code instructions stored therein with the computer program code instructions configured to, when executed by the processing circuitry, cause the apparatus at least to predict a parameter associated with a respective navigation satellite based on data associated with the respective navigation satellite or the propagation of signals transmitted thereby. The computer program code instructions are also configured to, when executed by the processing circuitry, cause the apparatus to provide, to a correction service, time information identifying the data used as a basis for predicting the parameter associated with the respective navigation satellite or the propagation of signals transmitted by the respective navigation satellite and to receive, from the correction service, a correction to the parameter that has been predicted for the respective navigation satellite. The computer program code instructions are further configured to, when executed by the processing circuitry, cause the apparatus to determine the position of the client computing device based at least in part upon the parameter that has been predicted in combination with the correction thereto.

The computer program code instructions are further configured to, when executed by the processing circuitry, cause the apparatus of an example embodiment to apply the correction to the parameter that has been predicted for the respective navigation satellite or the propagation of signals transmitted by the respective navigation satellite in order to update the parameter that has been predicted. In an example embodiment, the apparatus is caused to predict the parameter by predicting one or more of an orbit or a clock of the respective navigation satellite based on ephemeris data associated with the respective navigation satellite and also caused to receive the correction by receiving a correction to one or more of the orbit or the clock that have been predicted. The apparatus of an example embodiment is caused to predict one or more of the orbit or the clock of the respective navigation satellite by utilizing ephemeris extension initialized with the ephemeris data to predict one or more of the orbit or the clock of the respective navigation satellite. The apparatus of an example embodiment is caused to predict the parameter by predicting one or more of a code bias, an ionospheric model, a tropospheric model or a phase bias and to receive the correction by receiving a correction to the one or more of the code bias, the ionospheric model, the tropospheric model or the phase bias that have been predicted. In this example embodiment, the computer program code instructions configured to determine the position of the client computing device include computer program code instructions configured to determine the position of the client computing device based also upon the one or more of the code bias, the ionospheric model, the tropospheric model or the phase bias that have been predicted in combination with the correction thereto. In an example embodiment, the correction to the one or more of the code bias, the ionospheric model, the tropospheric model or the phase bias may be received from the correction service at an update rate that is less than the update rate at which the correction to one or more of the orbit or the clock is received from the correction service. In an example embodiment, the computer program code instructions configured to receive the correction to one or more of the orbit or the clock include computer program code instructions configured to receive the correction to one or more of the orbit or the clock as a polynomial model.

In a further example embodiment, a computer program product is provided that is configured to determine a position of a client computing device. The computer program product includes at least one non-transitory computer-readable storage medium having computer-executable program code instructions stored therein with the computer-executable program code instructions including program code instructions configured to predict a parameter associated with a respective navigation satellite or propagation of signals transmitted by the respective navigation satellite based on data associated with the respective navigation satellite or the propagation of signals transmitted thereby. The computer-executable program code instructions also include program code instructions configured to provide, to a correction service, time information identifying the data used as a basis for predicting the parameter associated with the respective navigation satellite or the propagation of signals transmitted by the respective navigation satellite. The computer-executable program code instructions further include program code instructions configured to receive, from the correction service, a correction to the parameter that has been predicted and program code instructions configured to determine the position of the client computing device based at least in part upon the parameter that has been predicted in combination with the correction thereto.

The computer-executable program code instructions of an example embodiment also include program code instructions configured to apply the correction to the parameter that has been predicted for the respective navigation satellite or the propagation of signals transmitted by the respective navigation satellite in order to update the parameter that has been predicted. In an example embodiment, the program code instructions configured to predict the parameter include program code instructions configured to predict one or more of an orbit or a clock of the respective navigation satellite based on ephemeris data associated with the respective navigation satellite and the program code instructions configured to receive the correction include program code instructions configured to receive a correction to one or more of the orbit or the clock that have been predicted. In this example embodiment, the program code instructions configured to predict one or more of the orbit or the clock of the respective navigation satellite may include program code instructions configured to utilize ephemeris extension initialized with the ephemeris data to predict one or more of the orbit or the clock of the respective navigation satellite. In an example embodiment, the program code instructions configured to predict the parameter include program code instructions configured to predict one or more of a code bias, an ionospheric model, a tropospheric model or a phase bias and the program code instructions configured to receive the correction include program code instructions configured to receive a correction to the one or more of the code bias, the ionospheric model, the tropospheric model or the phase bias that have been predicted. In this example embodiment, the program code instructions configured to determine the position of the client computing device include program code instructions configured to determine the position of the client computing device based also upon the one or more of the code bias, the ionospheric model, the tropospheric model or the phase bias that have been predicted in combination with the correction thereto. In an example embodiment, the correction to the one or more of the code bias, the ionospheric model, the tropospheric model or the phase bias may be received from the correction service at an update rate that is less than the update rate at which the correction to one or more of the orbit or the clock is received from the correction service. In an example embodiment, the program code instructions configured to receive the correction to one or more of the orbit or the clock include program code instructions configured to receive the correction to one or more of the orbit or the clock as a polynomial model.

In yet another example embodiment, an apparatus is provided that is configured to determine a position of a client computing device. The apparatus includes means for predicting a parameter associated with a respective navigation satellite or propagation of signals transmitted by the respective navigation satellite based on data associated with the respective navigation satellite or the propagation of signals transmitted thereby. The apparatus also includes means for providing, to a correction service, time information identifying the data used as a basis for predicting the parameter associated with the respective navigation satellite or the propagation of signals transmitted by the respective navigation satellite. The apparatus further includes means for receiving, from the correction service, a correction to the parameter that has been predicted and means for determining the position of the client computing device based at least in part upon the parameter that has been predicted in combination with the correction thereto.

The apparatus of an example embodiment also includes means for applying the correction to the parameter that has been predicted for the respective navigation satellite or the propagation of signals transmitted by the respective navigation satellite in order to update the parameter that has been predicted. In an example embodiment, the means for predicting the parameter includes means for predicting one or more of an orbit or a clock of the respective navigation satellite based on ephemeris data associated with the respective navigation satellite and the means for receiving the correction includes means for receiving a correction to one or more of the orbit or the clock that have been predicted. In this example embodiment, the means for predicting one or more of the orbit or the clock of the respective navigation satellite may include means for utilizing ephemeris extension initialized with the ephemeris data to predict one or more of the orbit or the clock of the respective navigation satellite. In an example embodiment, the means for predicting the parameter includes means for predicting one or more of a code bias, an ionospheric model, a tropospheric model or a phase bias and the means for receiving a correction includes means for receiving a correction to the one or more of the code bias, the ionospheric model, the tropospheric model or the phase bias that have been predicted. In this example embodiment, the means for determining the position of the client computing device includes means for determining the position of the client computing device based also upon the one or more of the code bias, the ionospheric model, the tropospheric model or the phase bias that have been predicted in combination with the correction thereto. In an example embodiment, the correction to the one or more of the code bias, the ionospheric model, the tropospheric model or the phase bias may be received from the correction service at an update rate that is less than the update rate at which the correction to one or more of the orbit or the clock is received from the correction service. The means for receiving the correction to one or more of the orbit or the clock in accordance with an example embodiment includes means for receiving the correction to one or more of the orbit or the clock as a polynomial model.

In an example embodiment, a method is provided for determining a correction to be applied to a parameter associated with a respective navigation satellite or propagation of signals transmitted by the respective navigation satellite. The method includes receiving, from a client computing device, time information identifying data associated with the respective navigation satellite and used by the client computing device as a basis for predicting the parameter associated with the respective navigation satellite or the propagation of signals transmitted by the respective navigation satellite. The method also includes predicting, with a server computing device, the parameter associated with the respective navigation satellite or the propagation of signals transmitted by the respective navigation satellite based on the data identified by the time information from the client computing device. The method further includes determining a correction to the parameter that has been predicted and providing, to the client computing device, the correction to the parameter that has been predicted.

The method of an example embodiment predicts the parameter by predicting one or more of an orbit or a clock of the respective navigation satellite based on ephemeris data associated with the respective navigation satellite and identified by the time information from the client computing device. In this example embodiment, the method may also include accessing corresponding ephemeris data associated with the respective navigation satellite based upon the time information received from the client computing device that identifies the ephemeris data utilized by the client computing device to predict one or more of the orbit or the clock of the respective navigation satellite. In this example embodiment, predicting one or more of the orbit or the clock of the respective navigation satellite may include utilizing ephemeris extension initialized with the corresponding ephemeris data to predict one or more of the orbit or the clock of the respective navigation satellite. The method of an example embodiment also predicts the parameter by predicting one or more of a code bias, an ionospheric model, a tropospheric model or a phase bias and provides a correction by providing a correction to the one or more of the code bias, the ionospheric model, the tropospheric model or the phase bias that have been predicted by the client computing device. In this example embodiment, the correction to the one or more of the code bias, the ionospheric model, the tropospheric model or the phase bias may be provided to the client computing device at an update rate that is less than the update rate at which the correction to one or more of the orbit or the clock is provided to the client computing device. The method of an example embodiment provides the correction to one or more of the orbit or the clock by providing the correction to one or more of the orbit or the clock as a polynomial model.

In another example embodiment, an apparatus is provided that is configured to determine a correction to be applied to a parameter associated with a respective navigation satellite or propagation of signals transmitted by the respective navigation satellite. The apparatus includes processing circuitry and at least one non-transitory memory including computer program code instructions stored therein with the computer program code instructions configured to, when executed by the processing circuitry, cause the apparatus at least to receive, from a client computing device, time information identifying data associated with the respective navigation satellite and used by the client computing device as a basis for predicting the parameter associated with the respective navigation satellite or the propagation of signals transmitted by the respective navigation satellite. The computer program code instructions are also configured to, when executed by the processing circuitry, cause the apparatus to predict the parameter associated with the respective navigation satellite or the propagation of signals transmitted by the respective navigation satellite based on the data identified by the time information from the client computing device. The computer program code instructions are further configured to, when executed by the processing circuitry, cause the apparatus to determine a correction to the parameter that has been predicted for the respective navigation satellite and to provide, to the client computing device, the correction to the parameter that has been predicted.

The program code instructions configured to predict the parameter are configured, in accordance with an example embodiment, to predict one or more of an orbit or a clock of the respective navigation satellite based on ephemeris data associated with the respective navigation satellite and identified by the time information from the client computing device. In an example embodiment, the computer program code instructions are further configured to, when executed by the processing circuitry, cause the apparatus to access corresponding ephemeris data associated with the respective navigation satellite based upon the time information received from the client computing device that identifies the ephemeris data utilized by the client computing device to predict one or more of the orbit or the clock of the respective navigation satellite. The apparatus of an example embodiment is caused to predict one or more of the orbit or the clock of the respective navigation satellite by utilizing ephemeris extension initialized with the corresponding ephemeris data to predict one or more of the orbit or the clock of the respective navigation satellite. In an example embodiment, the computer program code instructions configured to predict the parameter include program code instructions configured to predict one or more of a code bias, an ionospheric model, a tropospheric model or a phase bias and the program code instructions configured to provide a correction include program code instructions configured to provide a correction to the one or more of the code bias, the ionospheric model, the tropospheric model or the phase bias that have been predicted by the client computing device. In this example embodiment, the correction to the one or more of the code bias, the ionospheric model, the tropospheric model or the phase bias may be provided to the client computing device at an update rate that is less than the update rate at which the correction to one or more of the orbit or the clock is provided to the client computing device. By way of example but not of limitation, the computer program code instructions configured to provide the correction to one or more of the orbit or the clock may include computer program code instructions configured to provide the correction to one or more of the orbit or the clock as a polynomial model. In an example embodiment, the apparatus is embodied by a server computing device configured to provide a correction service to a plurality of client computing devices.

In a further example embodiment, a computer program product is provided that is configured to determine a correction to be applied to a parameter associated with a respective navigation satellite or propagation of signals transmitted by the respective navigation satellite. The computer program product includes at least one non-transitory computer-readable storage medium having computer-executable program code instructions stored therein with the computer-executable program code instructions including program code instructions configured to receive, from a client computing device, time information identifying data associated with the respective navigation satellite and used by the client computing device as a basis for predicting the parameter associated with the respective navigation satellite or the propagation of signals transmitted by the respective navigation satellite. The computer-executable program code instructions also include program code instructions configured to predict the parameter associated with the respective navigation satellite or the propagation of signals transmitted by the respective navigation satellite based on the data identified by the time information from the client computing device. The computer-executable program code instructions further include program code instructions configured to determine a correction to the parameter that has been predicted for the respective navigation satellite and program code instructions configured to provide, to the client computing device, the correction to the parameter that has been predicted.

The program code instructions configured to predict the parameter may include program code instructions configured to predict one or more of an orbit or a clock of the respective navigation satellite based on ephemeris data associated with the respective navigation satellite and identified by the time information from the client computing device. The computer-executable program code instructions of an example embodiment also include program code instructions configured to access corresponding ephemeris data associated with the respective navigation satellite based upon the time information received from the client computing device that identifies the ephemeris data utilized by the client computing device to predict one or more of the orbit or the clock of the respective navigation satellite. In this example embodiment, the program code instructions configured to predict one or more of the orbit or the clock of the respective navigation satellite include program code instructions configured to utilize ephemeris extension initialized with the corresponding ephemeris data to predict one or more of the orbit or the clock of the respective navigation satellite. The program code instructions configured to predict the parameter may include program code instructions configured to predict one or more of a code bias, an ionospheric model, a tropospheric model or a phase bias and the program code instructions configured to provide a correction may include program code instructions configured to provide a correction to the one or more of the code bias, the ionospheric model, the tropospheric model or the phase bias that have been predicted by the client computing device. In this example embodiment, the correction to the one or more of the code bias, the ionospheric model, the tropospheric model or the phase bias may be provided to the client computing device at an update rate that is less than the update rate at which the correction to one or more of the orbit or the clock is provided to the client computing device. By way of example but not of limitation, the program code instructions configured to provide the correction to one or more of the orbit or the clock in accordance with an example embodiment may include program code instructions configured to provide the correction to one or more of the orbit or the clock as a polynomial model.

In yet another example embodiment, an apparatus is provided that is configured to determine a correction to be applied to a parameter associated with a respective navigation satellite or propagation of signals transmitted by the respective navigation satellite. The apparatus includes means for receiving, from a client computing device, time information identifying data associated with the respective navigation satellite and used by the client computing device as a basis for predicting the parameter associated with the respective navigation satellite or the propagation of signals transmitted by the respective navigation satellite. The apparatus also includes means for predicting the parameter associated with the respective navigation satellite or the propagation of signals transmitted by the respective navigation satellite based on the data identified by the time information from the client computing device. The apparatus further includes means for determining a correction to the parameter that has been predicted for the respective navigation satellite and means for providing, to the client computing device, the correction to the parameter that has been predicted.

The means for predicting the parameter may include means for predicting one or more of an orbit or a clock of the respective navigation satellite based on ephemeris data associated with the respective navigation satellite and identified by the time information from the client computing device. The apparatus of an example embodiment also includes means for accessing corresponding ephemeris data associated with the respective navigation satellite based upon the time information received from the client computing device that identifies the ephemeris data utilized by the client computing device to predict one or more of the orbit or the clock of the respective navigation satellite. In this example embodiment, the means for predicting one or more of the orbit or the clock of the respective navigation satellite includes means for utilizing ephemeris extension initialized with the corresponding ephemeris data to predict one or more of the orbit or the clock of the respective navigation satellite. In an example embodiment, the means for predicting the parameter includes means for predicting one or more of a code bias, an ionospheric model, a tropospheric model or a phase bias and the means for providing the correction includes means for providing a correction to the one or more of the code bias, the ionospheric model, the tropospheric model or the phase bias that have been predicted by the client computing device. In this example embodiment, the correction to the one or more of the code bias, the ionospheric model, the tropospheric model or the phase bias may be provided to the client computing device at an update rate that is less than the update rate at which the correction to one or more of the orbit or the clock is provided to the client computing device. The means for providing the correction to one or more of the orbit or the clock in accordance with an example embodiment includes means for providing the correction to one or more of the orbit or the clock as a polynomial model.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a system for determining the position of a client computing device that embodies a GNSS receiver and that is in communication with a server computing device that determines a correction to a parameter, such as the orbit and/or the clock, that had been predicted by the client computing device for a navigation satellite or the propagation of signals transmitted by the navigation satellite in accordance with an example embodiment of the present disclosure;

FIG. 2 is a block diagram of an apparatus that may be embodied by a server computing device or a client computing device and that may be specifically configured in accordance with an example embodiment of the present disclosure;

FIG. 3 is a flowchart illustrating the operations performed, such as by the apparatus of FIG. 2 as embodied by a client computing device, in accordance with an example embodiment of the present disclosure;

FIG. 4 is a block diagram illustrating interaction between the client computing device and the server computing device in accordance with an example embodiment of the present disclosure; and

FIG. 5 is a flowchart illustrating the operations performed, such as by the apparatus of FIG. 2 as embodied by a server computing device, in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in order to determine the position of a client computing device based upon a correction provided by a server computing device, such as server computing device that provides a correction service. The correction provided by the server computing device may relate to a parameter associated with a respective navigation satellite, such as one or more of the orbit or the clock of the navigation satellite, or the propagation of signals transmitted by the navigation satellite, such as a code bias, an ionospheric model, a tropospheric model and/or a phase bias. By way of example, the method, apparatus and computer program product of one embodiment are therefor able to determine the position of a client computing device based upon one or more of the orbit or the clock of a navigation satellite that had been predicted in reliance upon ephemeris data associated with the respective navigation satellite in combination with a correction to one or more of the orbit or the clock of the respective navigation satellite that has been determined by the server computing device. By providing for the correction to the orbit and/or the clock that had been predicted for the respective navigation satellite, the position of the navigation satellite at a particular instance in time may be accurately determined such that the position of a GNSS receiver and, as a result, a client computing device that includes or is associated with the GNSS receiver may be correspondingly determined in an accurate manner even after the lifetime of the ephemeris data.

In one example embodiment that is described below, the determination of the correction to the parameter associated with the respective navigation satellite or the propagation of signals transmitted by the respective navigation satellite by the server computing device advantageously utilizes the more substantial computing resources of the server computing device, while conserving the generally more limited computing resources of the client computing device. Additionally, since the server computing device is configured to determine the correction to the parameter, the server computing device is also configured to receive the correction data upon which the correction is based, such as via a network connection, with the correction data at least sometimes being provided relatively frequently, such as every 5 to 30 seconds. Consequently, the client computing device need not receive and process the correction data, thereby further conserving computational and communication resources of the client computing device. Moreover, the client computing device can continue to accurately determine the position of the client computing device in a timely manner, such as with a relatively small TTFF, based upon the parameter, such as the orbit and/or clock, that had been predicted for the respective satellite in combination with the correction provided by the server computing device even in instances in which the client computing device lacks or has only intermittent network access since the server computing device, as opposed to the client computing device, receives the correction data. As a result, reliance upon the correction provided by the server computing devices provides for more accurate positioning than reliance by the client computing device solely upon a prediction of the parameter

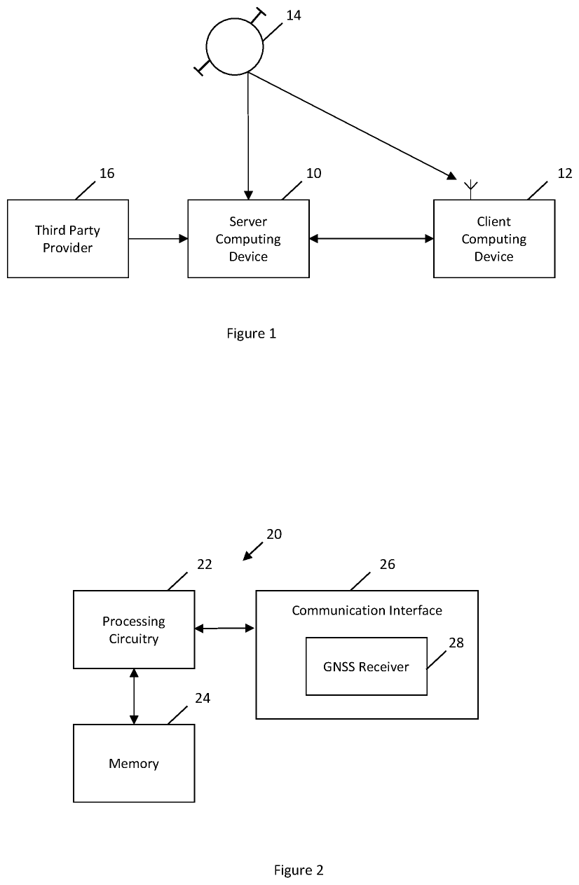

Referring now to FIG. 1, a server computing device 10 and a client computing device 12 receive data broadcast by a navigation satellite 14. Although shown and hereafter described to receive data broadcast by the navigation satellite, the server computing device may additionally or alternatively be in communication with a third party provider 16 and may receive ephemeris data therefrom. Although FIG. 1 depicts a single client computing device, the navigation satellite and the server computing device may be in communication with a plurality of client computing devices with the server computing device configured to provide a correction to the predicted position of the navigation satellite, such as a correction to a predicted parameter associated with the navigation satellite or the propagation of signals transmitted by the navigation satellite, at one or more points in time to each of the plurality of client computing devices. In addition, although a single navigation satellite is depicted for purposes of illustration, the navigation satellite is typically one of a constellation of navigation satellites that orbit the earth. For example, the navigation satellite may be a GNSS satellite, such as a GPS satellite, a GLONASS satellite, a Beidou satellite, a Galileo satellite or a regional SBAS satellite. Regardless of the type of navigation satellite, the navigation satellite provides signals, such as on a periodic basis, that includes a ranging code and ephemeris data interleaved with the ranging code that defines the orbit of the navigation satellite for the lifetime of the ephemeris data, such as for a predefined period of time, e.g., 2 to 4 hours. Based upon the ephemeris data, the position of the navigation satellite may be determined within the predefined period of time.

A server computing device 10 may be embodied by any of a variety of computing devices including, for example, a server, a cloud computing device, a computer workstation, a distributed network of computing devices, a personal computer, a positioning or navigation system or any other type of computing device. The server computing device of an example embodiment may include a receiver, such as a GNSS receiver, for receiving signals transmitted by the navigation satellite 14, such as a message including the ranging code and the ephemeris data. As described below, the server computing device may also include a communication interface, such as a network interface, to receive correction data from a third party provider 16, such as may be provided via the Internet or another terrestrial network, either in addition to or instead of receiving signals from the navigation satellite.

The client computing device 12 is also configured to communicate with the navigation satellite 14, as well as to receive information transmitted by the server computing device 10. As a result, the client computing device may also include a receiver, such as a GNSS receiver, for receiving the signals transmitted by the navigation satellite. The client computing device may be embodied by any of a variety of devices including, for example, a mobile device, such as a mobile terminal, e.g., a personal digital assistant (PDA), mobile telephone, smart phone, personal navigation device, smart watch, tablet computer, or any combination of the aforementioned and other types of portable computer devices, or a positioning or navigation system such as a positioning or navigation system onboard a vehicle, e.g., an automobile, a truck, a drone, a train, etc. In an example environment, however, the client computing device is an TOT device that includes a GNSS receiver. Regardless of the manner in which the client computing device is embodied, the client computing device is generally configured to predict the position of the navigation satellite, such as the orbit and/or the clock of the navigation satellite, at one or more points in time within a prediction interval. The prediction interval may extend temporally beyond a predefined period of time during which the ephemeris data is valid so as to predict the position of the navigation satellite at each of a plurality of points in time following the lifetime of the ephemeris data. Although the client computing device may be configured to predict the position of the navigation satellite at the plurality of points in time within the prediction interval in any of a variety of different manners, the client computing device of an example embodiment is configured to predict the position of the navigation satellite utilizing a prediction algorithm, such as a prediction algorithm that provides an ephemeris extension of the ephemeris data. In order to more accurately determine the position of the navigation satellite and, in turn, the position of the client computing device, the client computing device is also configured to determine its position based not only upon the predicted position of the navigation satellite at a respective point in time, but also a correction to the predicted position at the respective point in time that is provided by the server computing device.

An apparatus 20 that may be embodied by the client computing device 12 and/or the server computing device 10 is depicted in FIG. 2. As shown in FIG. 2, the apparatus includes processing circuitry 22, a memory device 24 and a communication interface 26.

In some embodiments, the processing circuitry 22 (and/or co-processors or any other processors assisting or otherwise associated with the processing circuitry) can be in communication with the memory device 24 via a bus for passing information among components of the apparatus 20. The memory device can be non-transitory and can include, for example, one or more volatile and/or non-volatile memories. In other words, for example, the memory device may be an electronic storage device (for example, a computer readable storage medium) comprising gates configured to store data (for example, bits) that can be retrievable by a machine (for example, a computing device like the processing circuitry). The memory device can be configured to store information, data, content, applications, instructions, or the like for enabling the apparatus to carry out various functions in accordance with an example embodiment of the present disclosure. For example, the memory device can be configured to buffer input data for processing by the processing circuitry. Additionally or alternatively, the memory device can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory device 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication between a client computing device 12 and a serving computing device 10. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication. In addition to supporting communication between a client computing device 12 and a serving computing device 10, the communication interface may also be configured to support communication with one or more navigation satellites 14. As such, the communication interface of an example embodiment may also include a satellite receiver, such as a GNSS receiver 28.

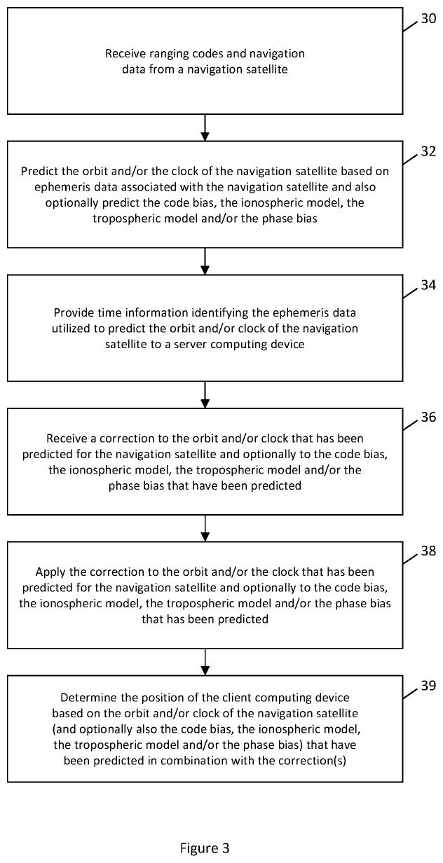

Referring now to FIG. 3, the operations performed by the apparatus 20, such as an apparatus embodied by a client computing device 12, are depicted. In shown in block 30, the apparatus includes means, such as the processing circuitry 22, the communication interface 26, the GNSS receiver 28 or the like, for receiving signals transmitted by the navigation satellite 14. The signals that are received may include ranging codes and navigation data, such as ephemeris data. The ephemeris data permits the orbit and, in turn, the position of the satellite to be determined as well as the clock of the satellite, such as the clock offset of the satellite relative to GNSS time, at one or more instances of time throughout the lifetime of the ephemeris data.

The apparatus 20 embodied by the client computing device 12 also includes means, such as the processing circuitry 22 or the like, for predicting a parameter associated with the navigation satellite 14, such as one or more of the orbit or the clock of the navigation satellite, or associated with the propagation of signals transmitted by the navigation satellite, such as a code bias, an ionospheric model, a tropospheric model and/or a phase bias, based on data associated with the navigation satellite or the propagation of signals transmitted thereby. As shown in block 32, for example, the means for predicting the parameter includes means, such as the processing circuitry 22 or the like, for predicting one or more of the orbit or the clock of the navigation satellite 14 based on the ephemeris data associated with the navigation satellite. While the apparatus, such as the processing circuitry, may be configured to predict one or more of the orbit or the clock of the respective navigation satellite during the lifetime of the ephemeris data, the apparatus, such as the processing circuitry, may also be configured to predict one or more of the orbit or the clock of the respective navigation satellite at one or more points in time within a prediction interval, such as a predetermined period of time, following, such as immediately following, the lifetime of the ephemeris data. The prediction interval during which the position of the navigation satellite is predicted can therefore extend beyond the lifetime of the ephemeris data and is based upon one or more positions of the navigation satellite that were determined based upon the ephemeris data within the lifetime of the ephemeris data. In this regard, the apparatus, such as the processing circuitry, may be configured to predict one or more of the orbit or the clock of the navigation satellite based upon a prediction algorithm that implements an ephemeris extension of the ephemeris data including, for example, any of the variety of ephemeris extension models described above. As such, the apparatus, such as the processing circuitry, may be configured to define the prediction of the orbit of the navigation satellite and the clock of the navigation satellite, such as the clock offset of the clock onboard the navigation satellite relative to GNSS time, in any of various manners including as a continuous polynomial function, such as a spline or Heremitea polynomial function, as a piecewise continuous function was a delta or differential correction to the ephemeris data or almanac, etc.

As noted above, the apparatus 20, such as the processing circuitry 22, may be configured to predict the position of the navigation satellite 14 at one or more points in time within the prediction interval in various manners. In this regard, the prediction of the position of the navigation satellite at the one or more points of time within the prediction interval includes the prediction of the orbit of the navigation satellite, the prediction of the clock offset of the clock of the navigation satellite or both. In an example embodiment, the apparatus, such as the processing circuitry, is configured to determine the position of the navigation satellite at the one or more points of time within the prediction interval in accordance with a prediction algorithm that is based upon gravitational forces of the earth, sun and moon and solar radiation pressure. In some example embodiments, the apparatus, such as the processing circuitry, is configured to determine the prediction of the position of the navigation satellite not only based upon the gravitational forces of the earth, sun and moon and solar radiation pressure, but also based upon one or more additional forces, such as the gravitational forces of other celestial body(ies), the tidal effect, solar radiation reflected from the surface of the earth, etc.

Ephemeris data for a navigation satellite 14 may be repeatedly received by the client computing device 10. For example, a different set of ephemeris data may be provided for a navigation satellite at a predefined frequency, such as every 2 hours. Each set of ephemeris data provides information regarding one or more of the orbit or the clock at the respective navigation satellite at a particular instance in time. Since the different sets of ephemeris data are associated with different instances in time, different sets of ephemeris data may be uniquely identified by time information, such as an issue of data ephemeris (IODE). As shown in block 34, the apparatus 20 of this example embodiment also includes means, such as the processing circuitry 22, communication interface 26 or the like, for providing time information to a correction service, such as a correction service provided by a server computing device 10. The time information identifies the data that is used as a basis for predicting the parameter associated with the navigation satellite or the propagation of signals transmitted by the navigation satellite. For example, the time information may identify the ephemeris data that is used as a basis for predicting one or more of the orbit or the clock of the respective navigation satellite. Any type of time information may be employed so long as both the server computing device and client computing device utilize the same type. However, in an example embodiment, the time information may be the ephemeris IODE that identifies the ephemeris data used as a basis for predicting one or more of the orbit or the clock of the respective navigation satellite, such as based on the time for which the client computing device predicted one or more of the orbit or the clock of the navigation satellite. In some embodiments, the time information may also include the length of the prediction so that the correction service is able to properly replicate the prediction and derive the correction. In other embodiments, however, such as in an instance in which the latest available prediction is utilized, the length of the prediction may not be necessary such that the time information need not include the length of prediction in those embodiments.

The time information that is provided to the correction service may identify the ephemeris data as described above. In this regard, in an embodiment in which correction data is provided as a polynomial model or otherwise has a time-dependent variable, time information that merely identifies the ephemeris data may be sufficient to identify the correction data. In other embodiments, however, both time information that identifies the ephemeris data as described above as well as a timestamp identifying the time of calculation may be provided to the correction service to insure that the proper correction data is identified. For example, if a correction is to be determined for the orbit of a satellite at a specific time instance, both the time of calculation as well as the time information associated with the ephemeris data may be provided to the correction service.

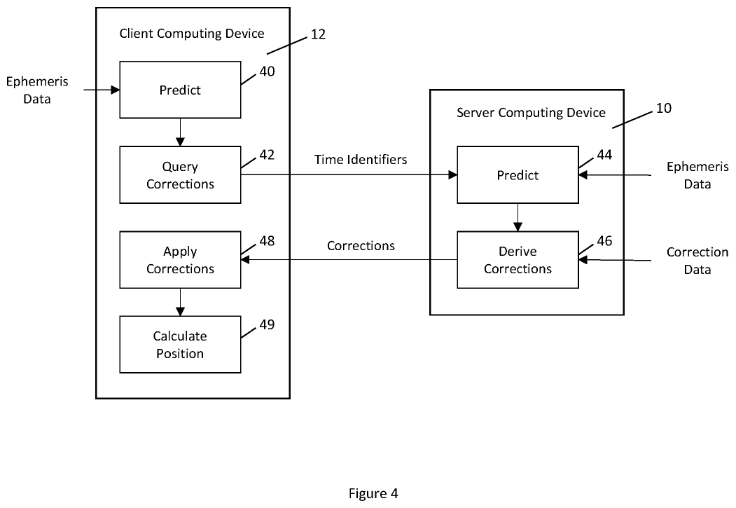

The communication between the apparatus 20 embodied by the client computing device 12 and the correction service provided by the server computing device 10 in accordance with one example embodiment is depicted in FIG. 4. As depicted in block 40 of FIG. 4, the client computing device of this example embodiment receives data, e.g., ephemeris data, such as from a respective navigation satellite 14, and predicts the parameter associated with the navigation satellite or the propagation of signals transmitted by the navigation satellite based upon the data, such as by predicting one or more of the orbit or the clock of the respective navigation satellite based upon the ephemeris data, such as in the manner described above in conjunction with blocks 30 and 32 of FIG. 3. In this regard, the client computing device may embody, implement or otherwise be associated with a prediction engine to predict the parameter, such as one or more of the orbit or the clock of the respective navigation satellite. The client computing device then queries the server computing device, such as a correction service provided by the server computing device, as to a correction to the parameter, e.g., the orbit and/or the clock, that has been predicted for the respective navigation satellite. As shown in block 42 of FIG. 4, this query provides time information identifying the data, e.g., ephemeris data, used as the basis for predicting the parameter, e.g., one or more of the orbit or the clock of the respective navigation satellite, to the server computing device, such as described above in conjunction with block 34 of FIG. 3.

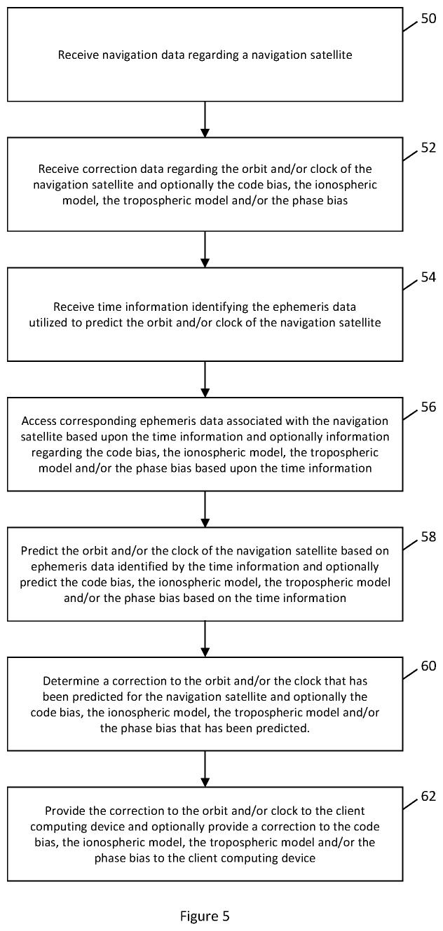

As also shown in FIG. 4 and like the client computing device 12, the server computing device 10 also receives data, e.g., ephemeris data, such as from the navigation satellite 14. As described in more detail below, the server computing device may be configured to store the data, such as the plurality of sets of ephemeris data, that are received over time in association with time information, such as an ephemeris IODE, that uniquely identifies the data, such as a set of ephemeris data. As described hereinbelow in conjunction with FIG. 5, the server computing device identifies the set of data, e.g., ephemeris data, that was utilized by the client computing device as the basis for predicting the parameter, e.g., one or more of orbit or the clock of the respective navigation satellite, based upon the time information that is provided by the client computing device. In this regard, each set of data, e.g., ephemeris data, that is received by the server computing device may be associated with a particular time, such as the time at which the set of ephemeris data is valid. As such, the server computing device of an example embodiment is configured to identify the set of stored data, e.g., ephemeris data, that is associated with the same time as the time information provided by the client computing device. By way of example, each set of ephemeris data stored by the server computing device may be associated with an ephemeris IODE, which serves as a time stamp for the set of ephemeris data. Thus, the server computing device may be configured to identify the set of stored ephemeris data having the same ephemeris IODE as the time information provided by the client computing device, such as the time for which the client computing device predicted one or more of the orbit or the clock of the navigation satellite. Utilizing the set of data, e.g., ephemeris data, that is identified based upon the time information, the server computing device then predicts the same parameter, such as one or more of the orbit or the clock of the respective navigation satellite. See block 44 of FIG. 4. As with the client computing device, the server computing device may embody, implement or otherwise be associated with a prediction engine to predict the parameter, such as one or more of the orbit or the clock of the respective navigation satellite. In the most advantageous embodiment, the prediction engines of the client computing device and the server computing device are identical.

As shown in FIG. 4, the server computing device 10 also receives correction data, such as Precise Point Positioning (PPP) data from a third party provider 16, via a network connection and, based upon the correction data, determines a correction to the parameter, such as one or more of the orbit or the clock that have been predicted for the respective navigation satellite 14. See block 46 of FIG. 4. The server computing device then provides the correction to the parameter that had been predicted, such as the correction to the orbit and/or the clock that had been predicted for the respective navigation satellite, to the client computing device 12 in response to the prior query from the client computing device.

The apparatus 20 embodied by the client computing device 12 also includes means, such as the processing circuitry 22, the communication interface 26 or the like, for receiving, from the server computing device 10, such as a correction service provided by the server computing device, a correction to the parameter that has been predicted, such as a correction to the orbit and/or the clock that had been predicted for respective navigation satellite 14 as shown in block 36 of FIG. 3. Although the correction to the orbit and/or the clock may be provided by the server computing device and received by the client computing device in various manners, the apparatus embodied by the client computing device of an example embodiment includes means, such as the processing circuitry, the communication interface and or the like, for receiving the correction to the orbit and/or the clock as a polynomial model. The apparatus embodied by the client computing device of this example embodiment also includes means, such as the processing circuitry or the like, for applying the correction to the parameter that has been predicted, such as the correction to the orbit and/or the clock that had been predicted for the respective navigation satellite, in order to update the parameter, such as the orbit and/or the clock of the respective navigation satellite, that had been predicted. See block 38 of FIG. 3 and block 48 of FIG. 4.

As shown in block 39 of FIG. 3 and block 49 of FIG. 4, the apparatus 20 embodied by the client computing device 12 also includes means, such as the processing circuitry 22 or the like, for determining the position of the client computing device based upon parameter that has been predicted, such as the one or more of orbit or the clock that had been predicted for the respective navigation satellite, in combination with the correction thereto. In this regard, the apparatus embodied by the client computing device, such as the processing circuitry, may be configured to determine the position of the navigation satellite based upon the orbit that has been predicted at a particular instant in time in combination with any correction to the predicted orbit. In this example embodiment, the apparatus embodied by the client computing device, such as the processing circuitry, may also be configured to define the particular instant in time for which the position of the navigation satellite is determined based upon the clock of the navigation satellite, such as the clock offset of the navigation satellite relative to the GNSS time, in combination with any correction to the clock of the navigation satellite. The apparatus embodied by the client computing device generally repeats the foregoing process of determining the position of a navigation satellite at a particular instant in time for each of a plurality of navigation satellites from which the GNSS receiver 28 of the client computing device receives signals. The determination of the position of the client computing device is not only based on the position of the navigation satellites, but also the time required for signals transmitted by the navigation satellites at the particular instant in time to be received by the client computing device as determined by reference to the ranging codes transmitted by the navigation satellites. As noted above, the time required for the ranging codes transmitted by each navigation satellite at the particular instant in time to be received by the client computing device corresponds to the distance between the respective navigation satellite and the client computing device.

By relying upon the server computing device 10, such as the correction service provided by the server computing device, to determine the correction to the parameter that has been predicted, such as the orbit and/or the clock that have been predicted for the respective satellite 14, the processing resources of the client computing device 12 are conserved while still providing for the accurate determination of the position of the navigation satellite and, in turn, the position of the client computing device. Additionally, by relying upon the server computing device to determine the correction to the parameter that has been predicted, such as the orbit and/or the clock that been predicted for the respective navigation satellite, the client computing device need not receive, store and process the correction data, which is typically provided relatively frequently, such as every 5 to 30 seconds, such that the position of the client computing device may be determined even in an instance in which the client computing device lacks or has only limited network access at the time at which the correction data was provided, thereby also reducing the TTFF in such instances by relying upon the network connection of the server computing device to receive the correction data in a timely manner.

In some example embodiments, the apparatus 20 embodied by the client computing device 12 may also take into account additional or different parameters that impact the determination at the position of the client computing device and that may allow for a more accurate determination of the position of the client computing device, such as parameters associated with the propagation of signals transmitted by a navigation satellite. In addition to or instead of the orbit and the clock of a navigation satellite, examples of these parameters include, but are not limited to a code bias, an ionospheric model, a tropospheric model and/or a phase bias. These parameters associated with the propagation of signals transmitted by the navigation satellite may be taken into account in addition to the parameters associated with the navigation satellite, such as one or more of the orbit or the clock of the navigation satellite, as shown in FIGS. 3 and 5 or instead of and without consideration of the parameters associated with the navigation satellite. As such, the apparatus embodied by the client computing device may optionally include means, such as the processing circuitry 22 or the like, for predicting one or more of the code bias regarding the respective navigation satellite 14, the ionospheric model, the tropospheric model or the phase bias regarding respective navigation satellite. See block 32 of FIG. 3. The prediction of the code bias, the ionospheric model, the tropospheric model and/or the phase bias may be based upon data received and stored by the client computing device regarding one or more of the code bias, the ionospheric model, the tropospheric model or the phase bias. Like the navigation data, the data regarding the code bias, the ionospheric model, the tropospheric model and/or the phase bias may be repeatedly received, albeit at least in some, but not necessarily all embodiments, less frequently than the navigation data, such as at an update rate that is less than the update rate at which the ephemeris data is received by the client computing device.

In this example embodiment, the server computing device 10 is also configured to repeatedly receive and store data regarding one or more of the code bias, the ionospheric model, the tropospheric model and/or the phase bias. Based upon the time information provided by the client computing device 12, the server computing device is also able to predict one or more of the code bias, the ionospheric model, the tropospheric model and/or the phase bias based upon the data regarding the one or more of the code bias, the ionospheric model, the tropospheric model and/or the phase bias that is associated with the instant in time for which the prediction is made, such as defined by the time information provided by the client computing device. The correction data that is received by the server computing device from a third party provider 16 may also include correction data regarding the code bias, the ionospheric model, the tropospheric model and/or the phase bias. As such, the server computing device of this example embodiment is configured to determine a correction to the code bias, the ionospheric model, the tropospheric model and/or the phase bias based upon the correction data and to provide a correction to the code bias, the ionospheric model, the tropospheric model and/or the phase bias to the client computing device.

In an example embodiment, the correction to the code bias, the ionospheric model, tropospheric model and/or the phase bias may be provided by the server computing device 10 in a different manner than the manner in which the correction is to the orbit and/or the clock of the respective navigation satellite 14 is provided to the client computing device 12. For example, the correction to the code bias, the ionospheric model, the tropospheric model and/or the phase bias may be provided as a polynomial fit, a differential correction or a grid point model in comparison to the correction to the orbit and/or the clock of the respective navigation satellite being provided as a polynomial model. The corrections may be provided in other manners if so desired.

The apparatus 20 embodied by the client computing device 12 of this example embodiment may also include means, such as processing circuitry 22, the communication interface 26 or the like, for receiving the correction to the one or more of the code bias, the ionospheric model, the tropospheric model or the phase bias that have been predicted. See block 36 of FIG. 3. The apparatus embodied by the client computing device of this example embodiment may therefore also include means, such as the processing circuitry, for applying the correction to the one or more of the code bias, the ionospheric model, the tropospheric model or the phase bias that have been predicted and means, such as the processing circuitry, for determining the position of the client computing device based not only upon the orbit an the clock that had been predicted for the respective navigation satellite 14 in combination with the correction thereto, but also based upon one or more of the code bias, the ionospheric model, the tropospheric model and/or the phase bias that have been predicted in combination with the correction thereto. See blocks 38 and 39 of FIG. 3.

As the code bias, the ionospheric model, the tropospheric model and the phase bias may be updated less frequently than the ephemeris data, the correction to the code bias, the ionospheric model, the tropospheric model and/or the phase bias may be provided by the server computing device 10 and received by the client computing device 12 at an update rate that is less than the update rate at which the correction to the orbit and/or the clock is provided, thereby also reducing the amount of data transmitted by the server computing device and received by the client computing device. Thus, computational resources of both the client computing device and the server computing device may be correspondingly conserved.

Referring now to FIG. 5, the operations performed by an apparatus 20 embodied by the server computing device 10 are depicted. As shown in block 50, the apparatus embodied by the server computing device include means, such as the processing circuitry 22, the communication interface 26, the GNSS receiver 28 or the like, for receiving data, such as ephemeris data, from the navigation satellite 14 or from another source, such as an assistance-data service. The apparatus embodied by the server computing device also includes means, such as the processing circuitry, the communication interface or the like, for receiving correction data regarding a parameter associated with the navigation satellite, such as one or more of the orbit or the clock of the respective navigation satellite, or associated with the propagation of signals transmitted by the respective navigation satellite, such as a code bias, an ionospheric model, a tropospheric model and/or a phase bias. See block 52. As such, the apparatus embodied by the server computing device may also include means, such as the processing circuitry, the communication interface or the like, for receiving correction data for one or more additional parameters, such as the code bias, the ionospheric model, the tropospheric model and/or the phase bias.

As shown in block 54 of FIG. 5, the apparatus 20 embodied by the server computing device 10 also includes means, such as the processing circuitry 22, the communication interface 26 or the like, for receiving time information, such as an ephemeris IODE, from the client computing device 12 identifying data, e.g., ephemeris data, associated with the respective navigation satellite 14 that was utilized by the client computing device as a basis for predicting the parameter, such as the orbit of the respective navigation satellite. Based upon the time information, the apparatus embodied by the server computing device, such as a processing circuitry, the memory 24 or the like, is configured to access the data, e.g., ephemeris data, that was utilized by the client computing device as a basis for the prediction of the parameter, such as the one or more of orbit or the clock for the respective navigation satellite. See block 56. In this regard, the apparatus embodied by the server computing device, such as the processing circuitry, is configured to access corresponding data, e.g., ephemeris data associated with respective navigation satellite, based upon the time information received from the client computing device that identifies the data, e.g., ephemeris data, utilized by the client computing device to predict the parameter, such as the one or more of orbit or the clock of a respective navigation satellite. The apparatus embodied by the server computing device also includes means, such as the processing circuitry or the like, for predicting the parameter associated with the navigation satellite or the propagation of signals transmitted by the navigation satellite. For example, the apparatus may include means, such as the processing circuitry or the like, for predicting one or more of the orbit or the clock of the respective navigation satellite based upon the ephemeris data identified by the time information from the client computing device. See block 58.

Additionally, the apparatus 20 embodied by the server computing device 10 includes means, such as the processing circuitry 22 or the like, for determining a correction to the parameter that has been predicted, such as a correction to one or more of the orbit or the clock have been predicted for the respective navigation satellite 14. See block 60 of FIG. 5. In this regard, the apparatus embodied by the server computing device, such as the processing circuitry, may be configured to determine the correction to the parameter that has been predicted, such as the orbit and/or the clock that have been predicted for the respective navigation satellite, based on the correction data that was previously received by the server computing device and that is associated with the time information that has been received from the client computing device 12, such as by being effective and valid for the instant in time associated with the data, e.g., ephemeris data. The apparatus embodied by the server computing device also includes means, such as the processing circuitry, the communication interface 26 or the like, for providing, to the client computing device, the correction to the parameter that has been predicated, such as the correction to one or more of the orbit or the clock that has been predicted for the respective navigation satellite. See block 62. As noted above, the correction to the orbit and/or the clock may be provided by the server computing device to the client computing device in any of various manners including as a polynomial model.

As noted above, corrections provided by the server computing device 10 may be to a parameter associated with the navigation satellite 14, such as the orbit and/or the clock of the navigation satellite, and/or to one or more additional or different parameters that impact the determination of the position of the client computing device 12, such as one or more parameters associated with the propagation of signals transmitted by the navigation satellite, so as to allow for a more accurate determination of the position of the client computing device. Examples of these additional or different parameters include, but are not limited to a code bias, an ionospheric model, a tropospheric model and/or a phase bias for a navigation satellite 14. As such, the apparatus embodied by the server computing device may optionally include means, such as the processing circuitry 22 or the like, for predicting a parameter associated with the propagation of signals transmitted by the respective navigation satellite, such one or more of the code bias regarding the respective navigation satellite, the ionospheric model, the tropospheric model or the phase bias regarding respective navigation satellite. See block 58 of FIG. 5. The prediction of the code bias, the ionospheric model, the tropospheric model and/or the phase bias may be based upon data received and stored by the server computing device regarding one or more of the code bias, the ionospheric model, the tropospheric model or the phase bias. Like the navigation data, the data regarding the code bias, the ionospheric model, the tropospheric model and/or the phase bias may be repeatedly received, albeit less frequently in some, but not necessarily all embodiments, than the navigation data, such as at an update rate that is less than the update rate at which the ephemeris data is received by the server computing device. As such, the apparatus embodied by the server computing device may include means, such as the processing circuitry, the memory device 24 or the like, for accessing the data regarding the code bias, the ionospheric model, the tropospheric model and/or the phase bias for the respective satellite based upon the time information received from the client computing device such that the data regarding the code bias, the ionospheric model, the tropospheric model and/or the phase bias that is valid at the time at which the orbit and/or the clock of the navigation satellite were predicted is accessed. See block 56.

In this example embodiment, based upon the correction data that has been received regarding the code bias, the ionospheric model, the tropospheric model and/or the phase bias, the server computing device includes means, such as the processing circuitry 22, for determining a correction to the code bias, the ionospheric model, the tropospheric model and/or the phase bias based upon the correction data and means, such as the processing circuitry, the communication interface 26 or the like, for providing a correction to the code bias, the ionospheric model, the tropospheric model and/or the phase bias to the client computing device 12. See blocks 60 and 62 of FIG. 5. As noted above, the correction to the code bias, the ionospheric model, the tropospheric model and/or the phase bias may be provided to the client computing device at an update rate that is less than that at which the correction to the orbit and/or the clock of the navigation satellite 14 is provided to the client computing device, thereby reducing the quantity of data transmitted by the server computing device and received by the client computing device.

As described above, the correction to the code bias, the ionospheric model, tropospheric model and/or the phase bias may be provided by the server computing device 10 in a different manner than the manner in which the correction is to the orbit and/or the clock of the respective navigation satellite 14 is provided to the client computing device 12. For example, the correction to the code bias, the ionospheric model, the tropospheric model and/or the phase bias may be provided as a polynomial fit, a differential correction or a grid point model in comparison to the correction to the orbit and/or the clock of the respective navigation satellite being provided as a polynomial model. The corrections may be provided in other manners if so desired.

Although described above in terms of any correction to the code bias, the ionospheric model, the tropospheric model and/or the phase bias being performed in addition to a correction to the orbit and/or the clock of a navigation satellite 14, the method, apparatus 20 and computer program product of another example embodiment is configured to correct the code bias, the ionospheric model, the tropospheric model and/or the phase bias without correction of the orbit and/or clock of the navigation satellite or with any correction of the orbit and/or clock of the navigation satellite being performed secondarily to the correction of the code bias, the ionospheric model, the tropospheric model and/or the phase bias. Thus, the foregoing description of the correction to the orbit and/or the clock of the navigation satellite is provided by way of example, but not of limitation, as the method, apparatus and computer program product may, instead, be configured to correct any one or more parameters impacting the signals transmitted by the navigation satellite for purposes of determining the position of a client computing device 12.

As described, a method, apparatus 20 and computer program product are provided for determining the position of a client computing device 12 in an efficient and accurate manner utilizing a correction to a parameter associated with a respective navigation satellite 14 or the propagation of signals transmitted by the respective navigation satellite. In order to accurately determine the position of the client computing device without consuming substantial computing resources of the client computing device, the parameter is predicted by the client computing device based on data, e.g., ephemeris data, while a correction to the parameter is determined by a server computing device 10, such as a correction service provided by the server computing device. As the server computing device receives the correction data from which the correction to the parameter is determined, the client computing device of this example embodiment need not necessarily also receive the correction data, but is still be able to correct the parameter based on a correction provided by the server computing device in an instance in which the client computing device is unable to consistently maintain a network connection, thereby providing for more accurate positioning than reliance by the client computing device solely upon a prediction of the parameter. Thus, a method, apparatus and computer program product of an example embodiment are also able to maintain a relatively small time-to-first-fix, even in an instance in which the client computing device lacks a consistent network connection.

As described above, FIGS. 3-5 are flowcharts of an apparatus 20, method, and computer program product configured to determine or enable determination of the position of a navigation satellite 14 according to an example embodiment. It will be understood that each block of the flowcharts, and combinations of blocks in the flowcharts, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory device 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for determining a position of a client computing device, the method comprising:
predicting, with the client computing device, a parameter associated with a respective navigation satellite or propagation of signals transmitted by the respective navigation satellite based on data associated with the respective navigation satellite or the propagation of signals transmitted thereby;
providing, to a correction service, time information identifying the data used as a basis for predicting the parameter associated with the respective navigation satellite or the propagation of signals transmitted by the respective navigation satellite;
receiving, from the correction service, a correction to the parameter that has been predicted; and
determining the position of the client computing device based at least in part upon the parameter that has been predicted in combination with the correction thereto.

2. A method according to claim 1, further comprising applying the correction to the parameter that has been predicted for the respective navigation satellite or the propagation of signals transmitted by the respective navigation satellite in order to update the parameter that has been predicted.

3. A method according to claim 1, wherein predicting the parameter comprises predicting one or more of an orbit or a clock of the respective navigation satellite based on ephemeris data associated with the respective navigation satellite, and wherein receiving the correction comprises receiving a correction to one or more of the orbit or the clock that have been predicted.

4. A method according to claim 3, wherein predicting one or more of the orbit or the clock of the respective navigation satellite comprises utilizing ephemeris extension initialized with the ephemeris data to predict one or more of the orbit or the clock of the respective navigation satellite.

5. A method according to claim 3, wherein:
predicting the parameter comprises predicting one or more of a code bias, an ionospheric model, a tropospheric model or a phase bias,
receiving the correction comprises receiving a correction to the one or more of the code bias, the ionospheric model, the tropospheric model or the phase bias that have been predicted, and
determining the position of the client computing device comprises determining the position of the client computing device based upon the one or more of the code bias, the ionospheric model, the tropospheric model or the phase bias that have been predicted in combination with the correction thereto.

6. A method according to claim 5, wherein the correction to the one or more of the code bias, the ionospheric model, the tropospheric model or the phase bias is received from the correction service at an update rate that is less than the update rate at which the correction to one or more of the orbit or the clock is received from the correction service.

7. An apparatus embodied by a client computing device and configured to determine a position of the client computing device, the apparatus comprising processing circuitry and at least one non-transitory memory including computer program code instructions stored therein, the computer program code instructions configured to, when executed by the processing circuitry, cause the apparatus at least to:
predict a parameter associated with a respective navigation satellite or propagation of signals transmitted by the respective navigation satellite based on data associated with the respective navigation satellite or the propagation of signals transmitted thereby;
provide, to a correction service, time information identifying the data used as a basis for predicting the parameter associated with the respective navigation satellite or the propagation of signals transmitted by the respective navigation satellite;
receive, from the correction service, a correction to the parameter that has been predicted; and
determine the position of the client computing device based at least in part upon the parameter that has been predicted in combination with the correction thereto.

8. An apparatus according to claim 7, wherein the computer program code instructions are further configured to, when executed by the processing circuitry, cause the apparatus to apply the correction to the parameter that has been predicted for the respective navigation satellite or the propagation of signals transmitted by the respective navigation satellite in order to update the parameter that has been predicted.

9. An apparatus according to claim 7, wherein the apparatus is caused to predict the parameter by predicting one or more of an orbit or a clock of the respective navigation satellite based on ephemeris data associated with the respective navigation satellite, and wherein the apparatus is caused to receive the correction by receiving a correction to one or more of the orbit or the clock that have been predicted.

10. An apparatus according to claim 9, wherein the apparatus is caused to predict one or more of the orbit or the clock of the respective navigation satellite by utilizing ephemeris extension initialized with the ephemeris data to predict one or more of the orbit or the clock of the respective navigation satellite.

11. A method for determining a correction to be applied to a parameter associated with a respective navigation satellite or propagation of signals transmitted by the respective navigation satellite, the method comprising:
receiving, from a client computing device, time information identifying data associated with the respective navigation satellite and used by the client computing device as a basis for predicting the parameter associated with the respective navigation satellite or the propagation of signals transmitted by the respective navigation satellite;
predicting, with a server computing device, the parameter associated with the respective navigation satellite or the propagation of signals transmitted by the respective navigation satellite based on the data identified by the time information from the client computing device;
determining a correction to the parameter that has been predicted; and
providing, to the client computing device, the correction to the parameter that has been predicted.

12. A method according to claim 11, wherein predicting the parameter comprises predicting one or more of an orbit or a clock of the respective navigation satellite based on ephemeris data associated with the respective navigation satellite and identified by the time information from the client computing device.

13. A method according to claim 12, further comprising accessing corresponding ephemeris data associated with the respective navigation satellite based upon the time information received from the client computing device that identifies the ephemeris data utilized by the client computing device to predict one or more of the orbit or the clock of the respective navigation satellite.

14. A method according to claim 12, wherein predicting one or more of the orbit or the clock of the respective navigation satellite comprises utilizing ephemeris extension initialized with the corresponding ephemeris data to predict one or more of the orbit or the clock of the respective navigation satellite.

15. A method according to claim 11, wherein:
predicting the parameter comprises predicting one or more of a code bias, an ionospheric model, a tropospheric model or a phase bias; and
providing the correction comprises providing a correction to the one or more of the code bias, the ionospheric model, the tropospheric model or the phase bias that have been predicted by the client computing device.

16. An apparatus configured to determine a correction to be applied to a parameter associated with a respective navigation satellite or propagation of signals transmitted by the respective navigation satellite, the apparatus comprising processing circuitry and at least one non-transitory memory including computer program code instructions stored therein, the computer program code instructions configured to, when executed by the processing circuitry, cause the apparatus at least to:
receive, from a client computing device, time information identifying data associated with the respective navigation satellite and used by the client computing device as a basis for predicting the parameter associated with the respective navigation satellite or the propagation of signals transmitted by the respective navigation satellite;
predict the parameter associated with the respective navigation satellite or the propagation of signals transmitted by the respective navigation satellite based on the data identified by the time information from the client computing device;
determine a correction to the parameter that has been predicted; and
provide, to the client computing device, the correction to the parameter that has been predicted.

17. An apparatus according to claim 16, wherein the apparatus is caused to predict the parameter by predicting one or more of an orbit or a clock of the respective navigation satellite based on ephemeris data associated with the respective navigation satellite and identified by the time information from the client computing device.

18. An apparatus according to claim 17, wherein the computer program code instructions are further configured to, when executed by the processing circuitry, cause the apparatus to access corresponding ephemeris data associated with the respective navigation satellite based upon the time information received from the client computing device that identifies the ephemeris data utilized by the client computing device to predict one or more of the orbit or the clock of the respective navigation satellite.

19. An apparatus according to claim 17, wherein the apparatus is caused to predict one or more of the orbit or the clock of the respective navigation satellite by utilizing ephemeris extension initialized with the corresponding ephemeris data to predict one or more of the orbit or the clock of the respective navigation satellite.

20. An apparatus according to claim 16, wherein the apparatus is caused to:
predict the parameter by predicting one or more of a code bias, an ionospheric model, a tropospheric model or a phase bias; and
provide the correction by providing a correction to the one or more of the code bias, the ionospheric model, the tropospheric model or the phase bias that have been predicted by the client computing device.
